(19) United States
(12) Patent Application Publication
(10) Pub. No.: US 2022/0363072 A1
(43) Pub. Date: Nov. 17, 2022

(54) PRINTING DEVICES FOR TWO-SIDED THERMAL MEDIA PRINTING

(71) Applicant: HEWLETT-PACKARD DEVELOPMENT COMPANY, L.P., Spring, TX (US)

(72) Inventors: Wesley R. SCHALK, Vancouver, WA (US); Jay S. GONDEK, Vancouver, WA (US); Jason M. QUINTANA, Vancouver, WA (US)

(21) Appl. No.: 17/771,384

(22) PCT Filed: Nov. 5, 2019
(86) PCT No.: PCT/US2019/059859

§ 371 Date: Apr. 22, 2022

(51) Int. Cl. B41J 2/355; B41J 3/60; B41J 3/36

(52) U.S. Cl. CPC B41J 2/355; B41J 3/60; B41J 3/36

(57) ABSTRACT

In one example in accordance with the present disclosure, a printing device is described. The printing device includes a single thermal printhead that includes an array of heating elements. The array of heating elements are selectively powered to form content on both sides of thermal media passing thereby. Different sides of the thermal media have thermal dye layers with different activation sensitivities. The printing device also includes a media transport system to move the thermal media by the single thermal printhead. A controller of the printing device generates printed content on both sides of the thermal media in a single pass by powering the single thermal printhead based on both content to be formed on a first side and content to be formed on a second side.

### BACKGROUND

Printing refers to the formation of text, images, and/or other patterns on a substrate such as paper. In some examples, a printing compound, such as ink or toner, is deposited on the substrate in predetermined patterns. In other examples, however, no printing compound is used. For example, in thermal printing, a special media referred to as thermal media is used. Thermal media includes a substrate with a material deposited thereon that changes color when exposed to heat. Accordingly, a thermal printing device selectively exposes the thermal media in particular areas that correspond to the text, images, and/or other patterns to print the intended content on the thermal media.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a printing device for two-sided thermal media printing, according to an example of the principles described herein.

FIG. 2 depicts a printing device for two-sided thermal media printing, according to an example of the principles described herein.

FIG. 3 depicts the printing device for two-sided thermal media printing, according to another example of the principles described herein.

FIG. 4 is a flow chart of a method for two-sided thermal media printing, according to an example of the principles described herein.

FIG. 5 is a diagram of print mode selection for two-sided thermal media printing, according to an example of the principles described herein.

FIG. 6 depicts the printing device for two-sided thermal media printing, according to another example of the principles described herein.

FIG. 7 depicts a non-transitory machine-readable storage medium for two-sided thermal media printing, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, one type of printing involves forming text and/or images on media that includes a thermal dye. As used in the present specification and in the appended claims, the term “thermal dye” refers to any compound, examples of which include dye and pigment, formed on a substrate that changes color when exposed to heat. Similarly, “thermal media” refers to the substrate that includes layers of thermal dye disposed thereon. Different heat sensitive coatings are available with a range of activation temperatures. In some examples, the longer a thermal dye layer is exposed to temperatures above its activation temperature, the higher the optical density of the thermal dye. As used in the present specification and in the appended claims, the term “high sensitivity dye” refers to a thermal dye that activates, or changes color, at temperatures below those of a “low sensitivity dye.” In some examples, a high sensitivity dye may activate around 70-80 degrees Celsius and a low sensitivity dye may activate around temperatures of 100 degrees Celsius.

The present specification describes devices and methods for performing two-sided printing on such thermal media. Two-sided printing of thermal media has several applications including duplex printing, gift/luggage tags, business cards, flash cards, and notes on a backside of photos to name a few. Some methods exist to allow printing on two-sided thermal media. However, such methods use two printheads that contact each side of the thermal media.

In other examples, two-sided printing is accomplished with direct thermal printers with one printhead. However, using these printers, a user first prints on one side, then manually flips and reloads the media to print the second side. While such methods facilitate two-sided printing on thermal media, they are inconvenient, ineffective, and costly. For example, manually flipping media is slow and inconvenient and may result in incorrect print orientation when printing on the second side. This may lead to a poor user experience associated with manually flipping and reloading printed media to print on the second side and a low success rate of reloading printed media with correct orientation to enable two-sided printing. Moreover, thermal printers with two printheads are expensive and large.

Accordingly, the present specification describes devices and methods that allow single-pass printing of two-sided thermal media in a direct thermal printer with a single printhead. In these devices, the thermal media has thermally sensitive dye layers on both sides of a substrate. By controlling power delivered to the thermal printhead over time, each of the dye layers, on both sides, may be activated independently. Two-sided printing is achieved in a single pass when two-sided thermal media is loaded with dye layers having higher activation temperatures on the side of the substrate contacting the thermal printhead.

The present devices and methods may operate on a variety of types of thermal media. In one example, yellow, magenta and cyan dye layers are on one side of a substrate and a black dye layer is formed on the opposite side of a substrate. In this example, the black dye layer may have low or high thermal sensitivity. In another example, a black dye layer is formed on each side of a substrate with each dye layer having different activation sensitivities.

Specifically, the present specification describes a printing device. The printing device includes a single thermal printhead that has an array of heating elements. The array of heating elements are selectively powered to form content on both sides of thermal media passing thereby. Different sides of the thermal media include thermal dye layers with different activation sensitivities. The printing device also includes a media transport system to move the thermal media by the single thermal printhead. A controller of the printing device generates printed content on both sides of the thermal media in a single pass by powering the single thermal printhead based on both content to be formed on a first side and content to be formed on a second side.

The present specification also describes a method. According to the method, thermal media having two sides is received at a printing device. Each side of the thermal media has a thermal dye layer with different activation sensitivities. The thermal media is moved by a single thermal printhead of the printing device. Single pass, two-side printing is performed on the thermal media by powering different heating elements of the single thermal printhead based on both content to be formed on a first side and content to be formed on a second side.

The present specification also describes a non-transitory machine-readable storage medium encoded with instructions executable by a processor. The machine-readable storage medium includes 1) instructions to provide data indicating a heating profile for first content to be formed on a first thermal dye layer on a first side of the thermal media, 2) instructions to provide data indicating a heating profile for second content to be formed on a second thermal dye layer on a second side of the thermal media, and 3) instructions to perform two-sided printing of the thermal media in a single pass by powering different heating elements of a single thermal printhead based on the heating profile for the first content and the heating profile for the second content.

Such devices and systems 1) facilitate two-sided printing on thermal media with a single printhead during a single printing pass; 2) have a low operating cost and small size; 3) offer more efficient printing and a simplified printing operation; and 4) waste less media due to a reduced likelihood of user error in re-loading media.

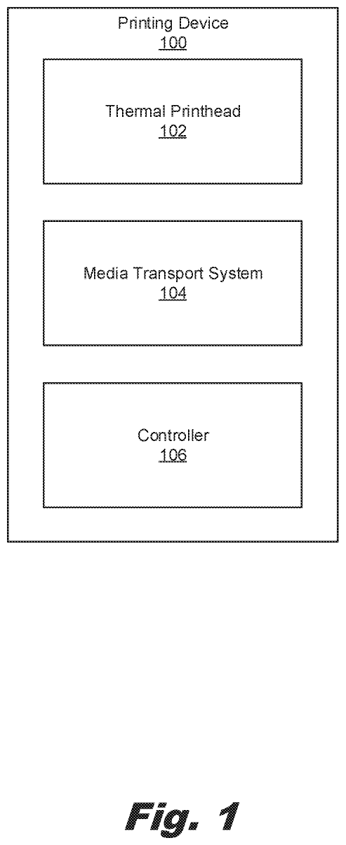

Turning now to the figures, FIG. 1 is a block diagram of a printing device (100) for two-sided thermal media printing, according to an example of the principles described herein. That is, the printing device (100) operates on thermal media to form content thereon. Specifically, the printing device (100) does so on both sides of the thermal media, at the same time.

The printing device (100) includes a single thermal printhead (102) that has an array of heating elements. The array of heating elements are selectively powered to form content on both sides of thermal media passing thereby. For example, the array may be a linear array that is perpendicular to a direction of travel of the media. At a particular point in time, each heating element of the linear array may heat to different temperatures, thus heating corresponding locations of the thermal media to different temperatures. As described in examples below, heating the thermal media to different temperatures may cause different thermal dye layers to develop. More particularly, as different sides of the thermal media have thermal dye layers with different activation sensitivities, different layers are activated by different heating elements of the array of heaters.

The printing device (100) also includes a media transport system (104) to move the thermal media by the single thermal printhead (102). As the thermal media moves, the different heating elements may change the amount of heat they apply to the thermal media. Again, the change in temperature alters which thermal dye layer of the thermal media is developed. Thus, as the thermal media moves, the array of heating elements are individually heating portions of the thermal media in different patterns, which results in a pattern forming on the thermal media.

The printing device (100) also includes a controller (106) to generate printed content on both sides of the thermal media in a single pass. This is done by powering the single thermal printhead based on both content to be formed on a first side and content to be formed on a second side of the thermal media. That is, the printing device (100) may receive data indicating a heating profile for first content to be formed on a first thermal dye layer, which heating profile indicates to what power and at what time different heating elements should be powered to produce the desired content. The printing device (100) may also receive similar data for second content to be formed on the second thermal dye layer, which may be on an underside of the substrate. If at a particular location, either heating profile indicates that a corresponding region of the thermal media is to be developed, the controller (106) powers a respective heating element to form the respective images. That is, the controller (106) powers the different heating elements of the thermal printhead (102) based on both data to generate content on both sides of the thermal media in a single pass.

Note that in this example, the controller (106) individually activates a thermal dye layer on the first side and a thermal dye layer on the second side. That is, during printing, the controller (106) may power the thermal printhead (102) to develop a line of content on the first side and then, before the thermal media moves away from the heating elements, may power the thermal printhead (102) to develop a line of content on the second side. This operation may be repeated over and over until the entire content on both the front side and the second side has been developed. As will be described in other examples, developing of a thermal dye layer on one side of the thermal media may not develop a thermal dye layer on another side of the thermal media.

In some examples, the printing device (100) may be handheld. That is, the printing device (100) may be a small format printing device (100). In some examples, the printing device (100) includes a tray in which sheets of thermal media are held. In another example, the printing device (100) may include a spindle to which a roll of thermal media may be attached.

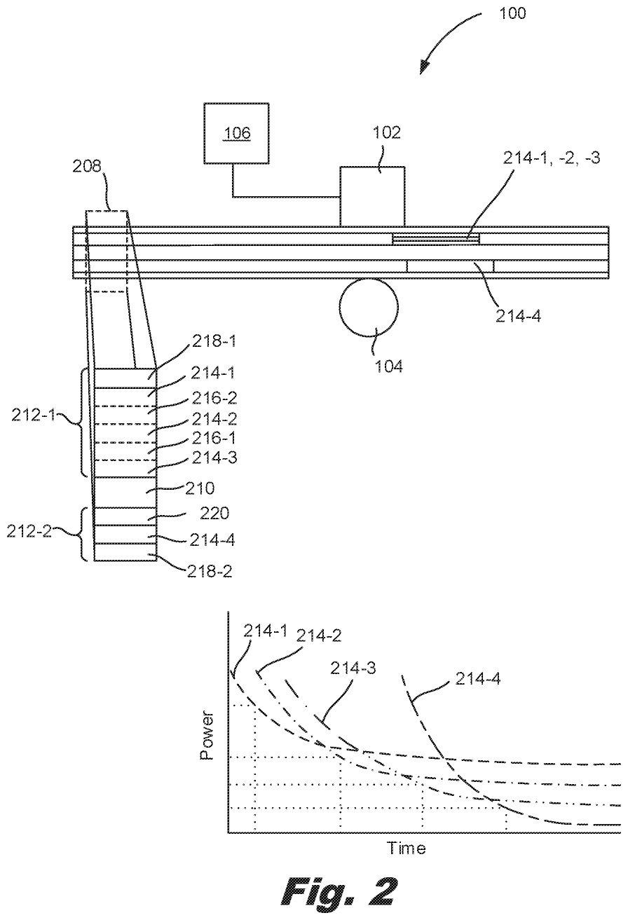

FIG. 2 depicts a printing device (100) for two-sided thermal media (208) printing, according to an example of the principles described herein. FIG. 2 depicts the thermal printhead (102), media transport system (104), and controller (106) as described above in connection with FIG. 1.

In some examples, the media transport system (104) includes a support member to bias the first side (212-1) of the thermal media (208) against the thermal printhead (102) such that the single thermal printhead (102) contacts just the first side (212-1) of the thermal media (208). The biased support member ensures contact between the thermal media (208) and the thermal printhead (102) to ensure high quality imaging. In one example, the thermal printhead (102) or the media transport system (104) may be adjusted to media thickness, for example via a dial or a spring force.

Notwithstanding contacting just the first side (212-1), the single thermal printhead (102) forms content on both the first side (212-1) of the thermal media (208) and the second side (212-2) of the thermal media (208). To do so, the printing device (100), and specifically the thermal printhead (102), targets different layers (214), both on a top surface and a bottom surface of the thermal media (208), at different power levels.

FIG. 2 depicts a layer-wise makeup of one example of thermal media (208), as well as the activation sensitivities of the different layers. As described above, thermal dye layers (214) on the first side (212-1) of the thermal media (208) may activate at a higher temperature than the thermal dye layers (214) on the second side (212-2).

In one particular example, multiple thermal dye layers (214-1, 214-2, 214-3) are formed on at least one side (212) of the thermal media (208), each pair of thermal dye layers (214) being separated by an insulating layer (216-1, 216-2). In this example, the different layers (214-1, 214-2, 214-3) on the one side (212-1) may change to different colors and have different activation sensitivities.

Specifically, lower layers (214) activate, or are developed, at a lower temperature than higher layers (214). For example, a first layer (214-1) may activate at a higher temperature than both the second layer (214-2) and the third layer (214-3), while the second layer (214-2) activates at a higher temperature than just the third layer (214-3). In so doing, the lower layers (214) may be developed without developing higher layers (214). For example, a first layer (214-1) may have the lowest activation sensitivity, meaning it absorbs the highest temperature to cause a change in color and a fourth layer (214-4), which may be on the second side (212-2), may have the highest activation sensitivity, meaning it absorbs the lowest temperature to cause a change in color. In this example, the lower thermal dye layers (214-2, 214-3) may take longer to reach activation temperature as compared to a top thermal dye layer (214-1) because of the insulation layers (216-1, 216-2).

The insulating layers (216-1, 216-2) between dye layers (214) and substrate (210) also enable heating of the upper dye layers (214) beyond their activation temperature while maintaining the layer (214-4) on the second side (212-2) below its activation temperature. The fourth layer (214-4) in turn can fully develop and power can be shut off to the thermal printhead (102) before developing any of the dye layers (214-1, 214-2, 214-3) on the first side (212-1).

As depicted in FIG. 2, a thermal dye layer (212-2) on at least one side of the thermal media (208) is a single layer. FIG. 2 depicts an example where one side (212-1) includes multiple layers (214) that change to different colors based on different applied powers and a second side (212-2) includes a single layer (214-4) that is monochromatic.

A specific example is now provided. In this example, yellow, magenta and cyan dye layers (214-1, 214-2, 214-3, respectively) sit on one side (212-1) of the substrate (210) with the yellow layer (214-1) positioned closest to the thermal printhead (102) followed by the magenta layer (214-2) and the cyan layer (214-3). Between each dye layer (214) is an insulating layer (216-1, 216-2). On the second side (212-2) of the substrate (210), another thermal dye layer (214-4) resides and is insulated from the first side (212-1) layers (214-1, 214-2, 214-3) by the substrate (210) and a base coat (220). Both sides (212-1, 212-2) may be coated with an overcoat (218-1, 218-2) protective layer to seal the thermal media (208) and protect against damage to the media and exposed layers (214-1, 214-4).

As described above, the controller (106) selectively powers the individual heating elements of the array to independently activate different dye layers (214). That is, pulse width-modulated control of the thermal printhead (102) enables activation of the different layers (214) independently. The colored layers may start colorless but become more chromatic the longer they are exposed to temperatures above their respective activation temperatures.

As depicted in the graph of FIG. 2, each of the different layers (214) have different activation sensitivities. For example, to develop the layer (214-4) on the second side (212-2), the thermal printhead (102) may be operated at a first temperature for a period of time. Note that as depicted in FIG. 2, there is a temperature at which the thermal printhead (102) can operate which will develop the fourth, or monochromatic, layer (214-4) on the second side (212-2), that will not develop any of the above layers (214-1, 214-2, 214-3).

Similarly, to develop the cyan layer (214-3) on the first side (212-2), the thermal printhead (102) may be operated at a second temperature for a period of time, Note that as depicted in FIG. 2, there is a temperature at which the thermal printhead (102) can operate which will develop the third, or cyan layer (214-3) on the first side (212-1), that will not develop any of the above layers (214-1, 214-2).

Similarly, to develop the magenta layer (214-2) on the first side (212-1), the thermal printhead (102) may be operated at a third temperature for a period of time. Note that as depicted in FIG. 2, there is a temperature at which the thermal printhead (102) can operate which will develop the second, or magenta layer (214-2) on the first side (212-1), that will not develop any of the above layers (214-1).

Similarly, to develop the yellow layer (214-1) on the first side (212-1), the thermal printhead (102) may be operated at a fourth temperature for a period of time. Accordingly, the controller (106) receives a heating profile for an image to be formed on the second side (212-2) and an image to be formed on the first side (212-1), which heating profiles indicate which heating elements should be powered to what temperatures and for how long to ensure that appropriate layers are developed and others are not.

During printing, the thermal printhead (102) activates a thermal dye layer (214) with a higher activation sensitivity, i.e., a lower temperature required for developing, by exposing the thermal dye layer (214) to a lower temperature for a longer period of time as compared to a thermal dye layer (214) with a lower activation sensitivity. That is, as depicted in FIG. 2, for thermal dye layers (214) closer to the thermal printhead (102), temperature is increased and period of exposure is decreased.

In some examples, the printing device (100) can develop the layer(s) (214) on the first side (212-1) without developing the layer(s) on the second side (212-2), for example, by operating the heating elements fora period of time less than the period of time required to develop the layer (214-4) on the second side (212-2).

Similarly, the printing device (100) can develop the layer(s) (214-4) on the second side (212-2) without developing the layer(s) (214-1, 214-2, 214-3) on the first side (212-1), for example by operating the heating elements at a temperature lower than required to develop the layers (214-1, 214-2, 214-3) on the first side (212-1).

In one particular example, if content is to be formed on both sides (212-1, 212-2) of the thermal media (208) at the same location, a series of pulse modulations to each of the linear array may be performed. For example, thermal dye layers (214) on the first side (212-1) may be imaged, then before the thermal media (208) moves away from the heating elements, thermal dye layers (214) on the second side (212-2) are imaged.

As a specific example, suppose a yellow portion of an image is to be developed on the first side (212-1) and at that same location, a black portion of text is to be developed on the second side (212-2). In this example, the yellow dye layer (214-1) on the first side (212-1) would reach its activation temperature first by controlling power to the thermal printhead (102) over time; for example, a higher power over a shorter time. Because the black dye layer (214-4) on the second side (212-2) has extra insulation from the thermal printhead (102), it does not reach its activation temperature while the yellow dye layer (214-1) is being developed. The heating element corresponding to this location is then adjusted to a second and lower temperature. The black dye layer (214-4) on the second side (212-4) is then developed at this location with a lower power delivered to the thermal printhead (102) delivered over a longer time period. After the black portion is developed, the process is repeated before the thermal media (208) moves away from the heating elements, until a complete image on both sides (212-1, 212-2) of the thermal media (208) is produced. As a result, as the thermal media (208) exits the print region, defined as an area underneath the thermal printhead (102), a developed image on a first side and a developed image on a second side are formed. Moreover, the present printing device (100) allows for such printing in a single pass. That is, thermal media (208) is not re-loaded or pulled back through to print the image on the second side (212-2). Rather content on both sides (212-1, 212-2) can be simultaneously produced by altering the heating characteristics of the thermal printhead (102).

While FIG. 2 depicts a particular configuration of the thermal media (208) with colored sub-layers on a first side and a single sub-layer on a second side, different configurations may be implemented so long as those with lower activation sensitivities are disposed closer to the thermal printhead (102).

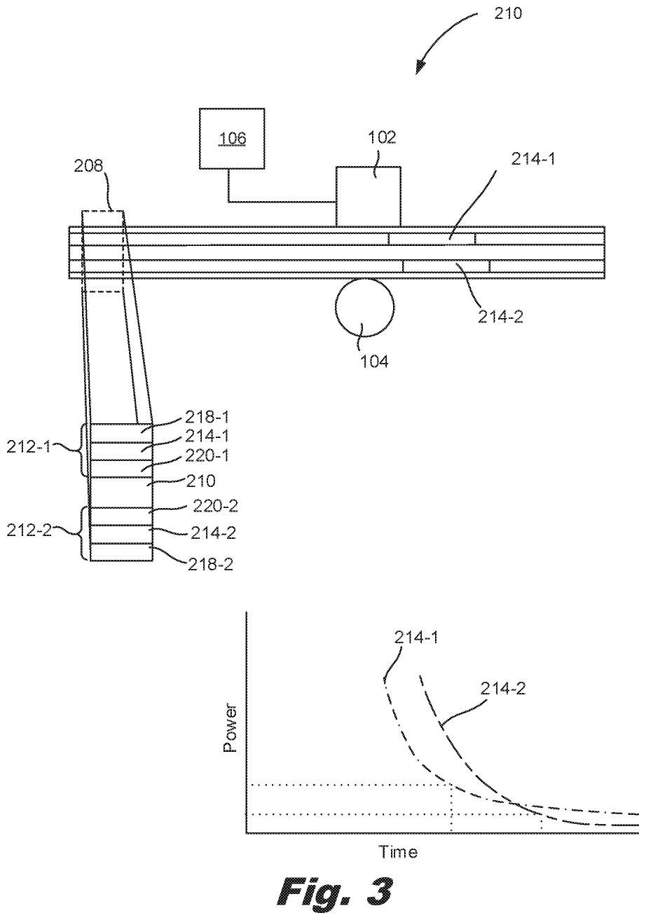

FIG. 3 is the printing device (100) for two-sided thermal media (208) printing, according to another example of the principles described herein. FIG. 3 depicts the thermal printhead (102), media transport system (104), and controller (106) as described above in connection with FIG. 1.

Similar to FIG. 2, FIG. 3 depicts the layer-wise makeup of the thermal media (208) as well as the activation sensitivities of the different layers (214). However, in this example, each side (212-1, 212-2) includes a single thermal dye layer (214-1, 214-2) sandwiched between a basecoat (220-1, 220-2) and an overcoat layer (218-1, 218-2). However, as with the example depicted in FIG. 2, the lower layer (214-2) activates at a lower temperature than a higher layer (214-1). In so doing, the lower layers (214) may be activated without activating higher layers (214). That is, the controller (106) may adjust the operation of the thermal printhead (102) to develop targeted layers (214).

As depicted in the graph of FIG. 3, each of the different layers (214-1, 214-2) have different activation sensitivities. For example, to develop the thermal dye layer (214-2) on the second side (212-2), the thermal printhead (102) may be operated at a first temperature for a period of time. Note that as depicted in FIG. 3, there is a temperature at which the thermal printhead (102) can operate which will develop the second thermal dye layer (214-2) on the second side (212-2), that will not develop any of the above thermal dye layers (214-1). Similarly, to develop the first thermal dye layer (214-1) on the first side (212-1), the thermal printhead (102) may be operated at a second temperature for a period of time.

Put another way, in the case of a two-sided single layer per side (212) thermal media (208), the thermal dye layer (214-1) on one side (212-1) of the substrate (210) has an activation temperature higher than the thermal dye layer (214-2) on the opposite side (212-2) of the substrate (210). The substrate (210) provides thermal insulation for the thermal dye layer (214-2) farthest from the printhead (102). As described above, pulse width-modulated control of the thermal printhead (102) enables activation of the top and bottom thermal dye layers (214) independently. During two-sided printing, the top thermal dye layer (214-1) can fully develop without activating the bottom thermal dye layer (214-2). The insulative substrate (210) between the top and bottom dye layers (214-1, 214-2) enables heating of the top dye layer (214-1) beyond its activation temperature while maintaining the bottom thermal dye layer (214-2) below its activation temperature. The bottom thermal dye layer (214-2) in turn can fully develop and power can be shut off to the printhead before developing the top thermal dye layer (214-1).

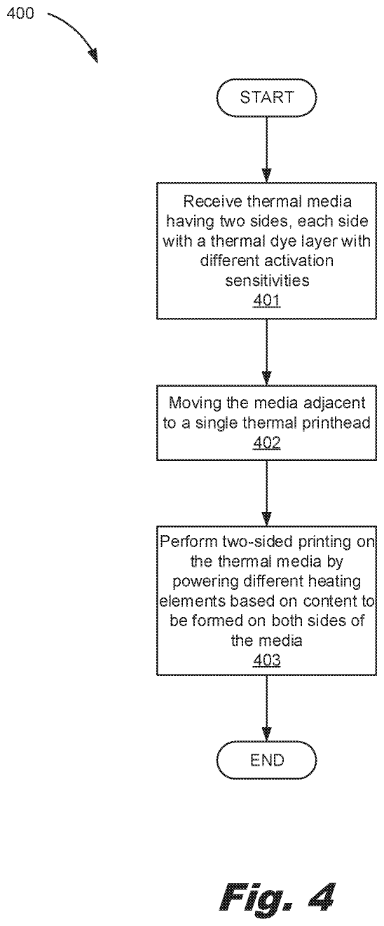

FIG. 4 is a flow chart of a method (400) for two-sided thermal media (FIG. 2, 208) printing, according to an example of the principles described herein. According to the method (400), thermal media (FIG. 2, 208) having two sides (FIG. 2, 212) is received (block 401) at a printing device (FIG. 1, 100). In some examples, the printing device (FIG. 1, 100) is opened up and the thermal media (FIG. 2, 208) is placed in a tray on the interior of the printing device (FIG. 1, 100). In another example, the printing device (FIG. 1, 100) includes a spool on which a roll of thermal media (FIG. 2, 208) may be placed. In yet another example, the printing device (FIG. 1, 100) may include a document feeder or slot through which thermal media (FIG. 2, 208) may be fed. Any variety of thermal media (FIG. 2, 208) may be implemented in accordance with the principles described herein including rolls of media, or single sheets such as blank business cards, sticky notes, index cards, and/or photographic paper.

As described above, each side (FIG. 2, 212) of the thermal media (FIG. 2, 208) may have thermal dye layers (FIG. 2, 214) that have different activation sensitivities, meaning that they change colors based on different heating patterns. Moreover, as described above, a thermal dye layer (FIG. 2, 214) on a second side (FIG. 2, 212), and therefore not in contact with the thermal printhead (FIG. 1, 102), may have a higher sensitivity, meaning it develops at a lower temperature, as compared to a thermal dye layer (FIG. 2, 214) on a first side (FIG. 2, 212-1) that contacts the thermal printhead (FIG. 1, 102).

In addition to receiving (block 401) the thermal media (FIG. 2, 208), the printing device (FIG. 1, 100), and specifically the controller (FIG. 1, 106), receives heating profile information for images to be formed on either side. As described above, the heating profile information for an image indicates how the different heating elements should be powered over time to form a particular image. The heating profile data for both images may be combined into one. That is, the heating profile information may indicate how to, over the course of printing, activate the different heating elements to form both images on either side (FIG. 2, 212) of the thermal media (FIG. 2, 208).

The thermal media (FIG. 2, 208) is moved (block 402) adjacent to, or by, a single thermal printhead (FIG. 1, 102) of the printing device (FIG. 1, 100) and two-sided printing is performed (block 403) on the thermal media (FIG. 2, 208). This is done by powering different heating elements of the single thermal printhead (FIG. 1, 102) based on both content to be formed on a first side (FIG. 2, 212-1) and content to be formed on a second side (FIG. 2, 212-2). That is, as the thermal media (FIG. 2, 208) moves past the thermal printhead (FIG. 1, 102), if the heating profile of the image on the first side or the heating profile on the second side indicates that a particular location is to be developed, the controller (FIG. 1, 106) powers the respective heating elements at that location to a particular temperature, and for a particular duration of time, to ensure that particular location is developed as intended. In doing so, heating elements are powered simultaneously, that is in one pass, to form content on both the first side (FIG. 2, 212-1) and the second side (FIG. 2, 212-2) of the thermal media (FIG. 2, 208).

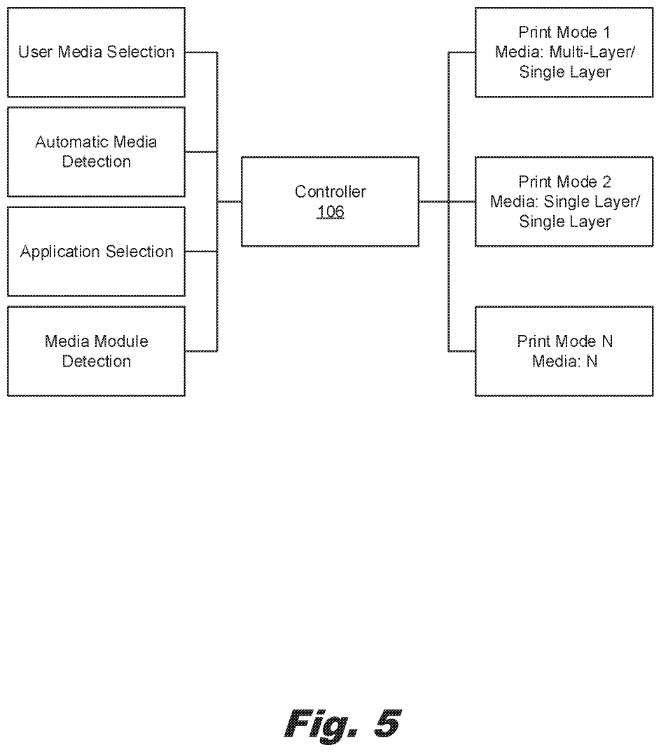

FIG. 5 is a diagram of print mode selection for two-sided thermal media (FIG. 2, 208) printing, according to an example of the principles described herein. As described above, two-sided thermal printing may be performed on a variety of two-sided thermal media (FIG. 2, 208). Accordingly, the controller (106) may detect the type of thermal media (FIG. 2, 208) and may control the thermal printhead (FIG. 1, 102) accordingly. For example, the controller (106) may determine that a first print mode, Print Mode 1, is to be executed, which Print Mode 1 corresponds to thermal media (FIG. 2, 208) having multiple thermal dye layers (FIG. 2, 214) on one side (FIG. 2, 212-1) and a single thermal dye layer (FIG. 2, 214) on the other side (FIG. 2, 212-2) as depicted in FIG. 2.

By comparison, the controller (106) may determine that a second print mode, Print Mode 2, is to be executed, which Print Mode 2 corresponds to media having a single thermal dye layer (FIG. 2, 214) on one side (FIG. 2, 212-1) and a single thermal dye layer (FIG. 2, 214) on the other side (FIG. 2, 212-2) as depicted in FIG. 3.

Other print modes may also be detected by the controller (106). Such a detection may be made by any number of methods including a user manually inputting the thermal media (FIG. 2, 208) type, a hardware component or media module of the printing device (FIG. 1, 100) determining the thermal media (FIG. 2, 208) type. In yet another example, an application executing on the printing device (FIG. 1, 100) ora computing device coupled to the printing device (FIG. 1, 100) may make the determination.

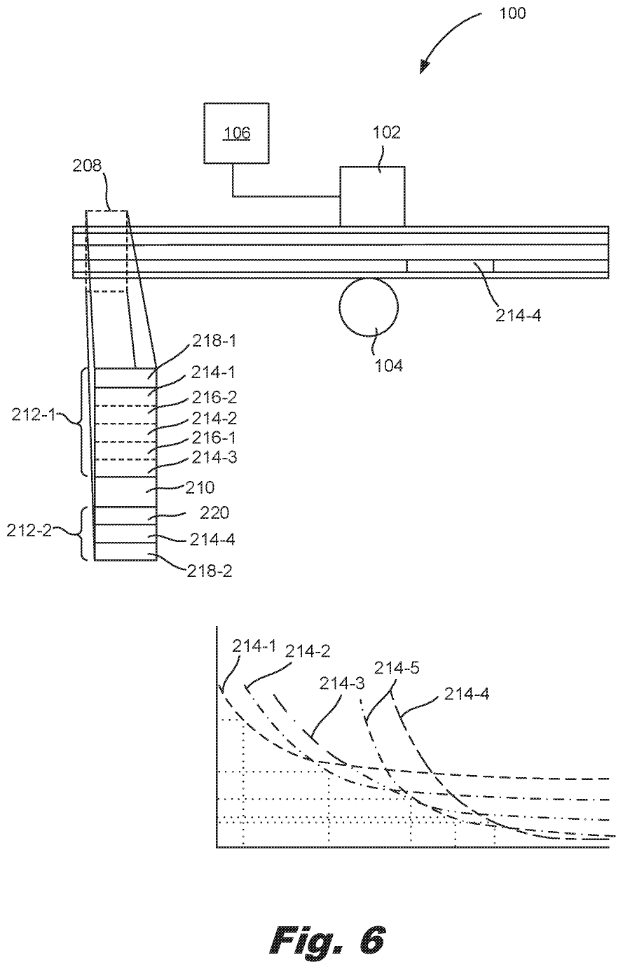

FIG. 6 is the printing device (100) for two-sided thermal media (208) printing, according to another example of the principles described herein. In the case that thermal media (208) with multiple layers (214) on at least one side was accidentally loaded in the printing device (100), where the print job calls for single layer (FIG. 2, 214) per side (FIG. 2, 212) printing, none of the yellow, magenta or cyan dye layers (214-1 214-2, 214-3) would develop because they have not reached their respective activation temperatures. That is, the temperature required to develop a single layer (214-5) that was intended to be printed on, but not actually inserted, is lower than the power or time required to activate the colored thermal dye layers (214-1, 214-2, 214-3) such that they would not be developed and the media may be printed again.

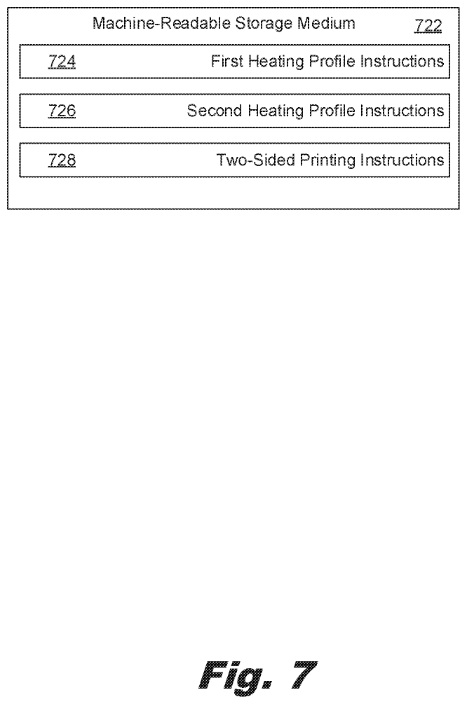

FIG. 7 depicts a non-transitory machine-readable storage medium (722) for two-sided thermal media (FIG. 2, 208) printing, according to an example of the principles described herein. To achieve its desired functionality, a computing system includes various hardware components. Specifically, a computing system includes a processor and a machine-readable storage medium (722). The machine-readable storage medium (722) is communicatively coupled to the processor. The machine-readable storage medium (722) includes a number of instructions (724, 726, 728) for performing a designated function. The machine-readable storage medium (722) causes the processor to execute the designated function of the instructions (724, 726, 728).

Referring to FIG. 7, first heating profile instructions (724), when executed by the processor, cause the processor to provide data indicating a heating profile for first content to be formed on a first thermal dye layer (FIG. 2, 214) on a first side (FIG. 2, 212-1) of the thermal media (FIG. 2, 208). Second heating profile instructions (726), when executed by the processor, cause the processor to provide data indicating a heating profile for second content to be formed on a second thermal dye layer (FIG. 2, 214) on a second side (FIG. 2, 212-2) of the thermal media (FIG. 2, 208). As described above, a heating profile indicates a power and duration for each of the heating elements, over time, of the single thermal printhead (FIG. 1, 102) to generate the content to be formed.

Two-sided printing instructions (728), when executed by the processor, may cause the processor to, perform two-sided printing of the thermal media (FIG. 2, 208) in a single pass by powering different heating elements of a single thermal printhead (FIG. 1, 102) based on the heating profile for the first content and the heating profile for the second content.

Such devices and systems 1) facilitate two-sided printing on thermal media with a single printhead during a single printing pass; 2) has a low operating cost and small size; 3) offers more efficient printing and a simplified printing operation; and 4) wastes less media due to a reduced likelihood of user error in re-loading media.

What is claimed is:

1. A printing device, comprising:
a single thermal printhead comprising an array of heating elements, the array of heating elements to be selectively powered to form content on both sides of thermal media passing thereby, wherein different sides of the thermal media comprise thermal dye layers with different activation sensitivities;
a media transport system to move the thermal media by the single thermal printhead; and
a controller to generate printed content on both sides of the thermal media in a single pass by powering the single thermal printhead based on both content to be formed on a first side and content to be formed on a second side.

2. The printing device of claim 1, wherein the array of heating elements is a linear array.

3. The printing device of claim 1, wherein the single thermal printhead is to:
contact just the first side of the thermal media; and
forms contents on both the first side of the thermal media and the second side of the thermal media.

4. The printing device of claim 3, wherein the media transport system comprises a support member to bias the first side of the thermal media against the single thermal printhead.

5. The printing device of claim 1, wherein the printing device is handheld.

6. The printing device of claim 1, wherein the controller individually activates a thermal dye layer on the first side and a thermal dye layer on the second side.

7. The printing device of claim 1, wherein a thermal dye layer on the first side activates at a higher temperature than a thermal dye layer on the second side.

8. A method, comprising:
receiving, at a printing device, thermal media having two sides, each side of the thermal media comprising at least one thermal dye layer with different activation sensitivities;
moving the thermal media by a thermal printhead of the printing device; and
performing single pass two-sided printing on the thermal media by powering heating elements of the single thermal printhead based on both content to be formed on a first side and content to be formed on a second side.

9. The method of claim 8, wherein heating elements are powered to simultaneously form content on the first side and content on the second side.

10. The method of claim 8, wherein:
at least one side of the thermal media comprises multiple thermal dye layers divided by an insulating layer; and
different thermal dye layers change to different colors and have different activation sensitivities.

11. The method of claim 10, wherein lower thermal dye layers are to activate at a lower temperature than higher thermal dye layers.

12. The method of claim 8, wherein at least one side of the thermal media comprises a single thermal dye layer.

13. The method of claim 8, wherein activating a thermal dye layer with a higher activation sensitivity comprises exposing the thermal dye layer to a lower temperature for a longer period of time as compared to a thermal dye layer with a lower activation sensitivity.

14. A non-transitory machine-readable storage medium encoded with instructions executable by a processor, the machine-readable storage medium comprising:
instructions to provide data indicating a heating profile for first content to be formed on a first thermal dye layer on a first side of thermal media;
instructions to provide data indicating a heating profile for second content to be formed on a second thermal dye layer on a second side of the thermal media; and
instructions to perform two-sided printing of the thermal media in a single pass by powering different heating elements of a single thermal printhead based on the heating profile for the first content and the heating profile for the second content.

15. The non-transitory machine-readable storage medium of claim 14, wherein a heating profile indicates a power and duration for each of the heating elements of the single thermal printhead to generate the content to be formed.
